(19) United States
(12) Patent Application Publication
(10) Pub. No.: US 2007/0280489 A1
(43) Pub. Date: Dec. 6, 2007

(54) DOCKING SYSTEM AND MIXER FOR PORTABLE MEDIA DEVICES WITH GRAPHICAL INTERFACE

(75) Inventors: Christopher Roman, Wrentham, MA (US); Rob Voisey, Willingham (GB); John B. Clark, Somerset (GB); Logan J. Kunz, Cambridge (GB); Michael Leighton, Sun Prairie, WI (US); Gregor Mittersinker, Warwick, RI (US); Jacob Sigal, Blacklick, OH (US)

Correspondence Address: BARLOW, JOSEPHS & HOLMES, LTD., 101 DYER STREET, 5TH FLOOR, PROVIDENCE, RI, 02903, US

(73) Assignee: Numark Industries, LLC, Cumberland, RI (US)

(21) Appl. No.: 11/691,582

(22) Filed: Mar. 27, 2007

Related U.S. Application Data
(60) Provisional application No. 60/743,876, filed on Mar. 28, 2006.

(51) Int. Cl. H04B 1/00

(52) U.S. Cl. 381/119

(57) ABSTRACT

A media player for a disc jockey is disclosed. The media player includes a housing with a top surface with a surface defining a seat configured to received a portable media device with a library of media tracks stored thereon. The seat includes an input port for connecting to the portable media device. The media player includes a master output, a first and a second deck having a first and second media control interface configured to cue and play media tracks on a first and second channel, respectively, and a global control interface including a main display, a rotatable and pressable select knob and a number of multifunction controls having contextual function labels associated therewith for navigating menus and selecting menu choices contained therein. A mixing controller is communicatingly connected to the interfaces, the input port, and the master output for accessing and controlling the portable media device according to selections made on the interfaces, for selectively mixing the first and the second channel into a mixed signal and routing the mixed signal out the master output.

### CROSS-REFERENCE TO RELATED APPLICATION

This application claims priority to earlier filed U.S. Provisional Application Ser. No. 60/743,876, filed Mar. 28, 2006, the contents of which are incorporated herein by reference.

### BACKGROUND OF THE INVENTION

1. Field of the Invention

The invention relates generally to equipment for playback and control of multimedia. More specifically, the present invention relates to disc jockey mixing equipment for control of the playback of multimedia files, such as audio and video files.

2. Background of the Related Art

In the music industry, there is a need for a person, such as a disc jockey, to be able to playback multimedia with control and precision. Such multimedia is available in many different forms. For example, it has been well known for many years that audio is available on analog vinyl discs. In particular, music recordings have been available on vinyl records and have been widely played by disc jockeys on turntables during a playback performance.

However, there is typically a need and desire to provide continuous music playback during a disc jockey performance. To carry this out, two or more turntables have been commonly employed whereby one turntable plays the current selection of music while the second turntable is used to cue up the next selection. When the first selection of music is nearing its end point or is at its end point, playback to the second turntable can be switched to the second turntable without interruption of the master output. It is also very well known that the transition from one turntable to another can be mixed or faded back and forth for seamless transition from one music selection to another. This back and forth transition and mixing can be carried out back and forth indefinitely during a disc jockey performance.

To carry out this mixing, a disc jockey mixing device is typically employed. The mixer commonly includes two inputs, one for each music source, such as a turntable, and a master output. A control interface is provided on the mixer so that the disc jockey can intuitively control the mixing and output of the media sources. This interface is critical so that the disc jockey can effectively control such mixing and playback output of the media for an engaging performance.

When turntables and vinyl records are used as the source for audio as the media, the cueing and playback of the audio are dictated by the turntable itself. The disc jockey must physically place the vinyl record on the turntable, place the needle on the desired spot and cue it up for playback when desired. When it is time for that selection to be outputted for playback, the mixer is manipulated to switch or fade to that selection so that it can be heard at the master output. When the selection is no longer desired, the turntable is the stopped by actuating the appropriate button or control on the turntable itself.

In general, the controls on the turntable itself are used to control playback and command operation of the turntable. As a result, disc jockey turntables provided with controls that are particularly well-suited for fast and easy control of a vinyl record. For example, play and cue buttons are typically very large and easily accessible, which is essential in a dark night club and where selection changes are frequent.

Vinyl records played back by turntables are a well known source of media for playback by a disc jockey, recently, there have been many new forms of digital media that are suitable for use by a disc jockey. For example, digital compact discs (CDs) are now a common storage format for media, such as digital audio. The digital audio is stored on an optical CD. Turntables are commonly substituted by compact disc players and mixed, as described above. Control of transport and operation of a CD and the audio files thereon can be carried out easily by providing disc jockey friendly operation controls thereon. For example, the playback/cue button can be large and intuitively placed on the CD player to facilitate the disc jockey performance.

In similar fashion to CDs, which store digital files on a optical disc, other storage media have been employed to store digital audio file for easy playback. For example, digital audio files can be stored on hard disks and memory RAM cards. These storage devices can also serve as the source of media files for later playback and mixing by a disc jockey. These storage devices can be separate units that serve as input sources for a disc jockey mixer, as an alternative media source for an analog turntable or CD player. For example, media players with hard disks and/or memory card slots for receipt of removable media are well known in the art. As with turntables and CD players, these are units that are provided with large and intuitive controls for playback and command of the media files. These controls are commonly specifically laid out and arranged for disc jockeys to facilitate their disc jockey performance.

It is also known in the art that CD players, hard disk players can be integrated with a disc jockey mixer for a single device solution. However, these units are still large enough and configured by design for use by disc jockeys.

Recently, portable media devices have become very popular for their compact size, large storage capacity and dropping cost. Portable media devices are available in the form of portable hard disk drives and, in particular, portable media players. These portable media players can playback audio files in many different formats, such as “mp3” and “wmv”. Also, many of these players can playback video files in different formats, such as “avi” and “divx”. For example, portable media players manufactured by Creative Technology Ltd., Apple Computer, Inc. and Archos, Inc. are widely sold with this capability.

These players typically include their own operating system and transport and command controls on the devices themselves so the user can playback and control files when desired. These portable devices are, essentially, personal players in that they are typically meant to be held in the hand or hands of the user so that the user can manipulate the controls for playback through headphones or a stereo system, for example.

While these transport and command controls are suitable for most uses of the portable players, there is often a need to enhance or improve the control of the personal player for other uses. For example, remote controls have been provided for portable media players. A receiver is connected to the portable player that is interconnected with the operating system of the player. A wireless remote that uses infrared, for example, includes a duplication of some or all of the transport and command controls of the actual device. Pressing a button on the remote transmits commands to the receiver to thereby control operation of the portable player. Such a wireless remote is well suited for operating a portable player from a distance without having to touch the player itself.

Many portable devices include their transport and command controls on the front face of the player. If the player is in a case without only its top edge exposed, the entire player must be removed so that the controls can be manipulated. To address this problem, there are prior art control modules that can be plugged into the edge of a players, such through it headphone jack which commonly includes additional contacts for access to the players operating system.

Alternatively, some of the transport and command controls can be duplicated on a tethered connection to the player, such as inline with the headphones. Due to the small size that is feasible on a small tethered control, only the primary transport and command controls are provided thereon.

In the prior art, it has also been known to provide a dock for receipt of the portable player therein where some of the controls are repeated on the dock to facilitate use. For example, many stand alone powered speaker units that include a dock for a portable media player have such duplicated controls for use to obviate the user to manipulate the controls on the player itself.

While the controls on a portable players are sufficient for a person to manipulate while in their hand, these controls are not well suited for use by a disc jockey during a performance. Moreover, duplicated transport and command controls for a portable media player, such as those on tethered remotes, plug-in modules and powered speakers are inadequate for use by disc jockeys. They are not laid out in an intuitive or logical fashion for use by a disc jockey. Moreover, none of them provide mixing capabilities between more than one portable player. Also, none of them can stream and mix audio from the same portable media players that is acting as a mass storage device. Further, none of the prior devices provide a way to mount the portable media player so its screen can be easily viewed in connection with its respective player controls. The prior art is also devoid of a device that has two separate dedicated sets of disc jockey style controls for controlling two streams of media from a source of stored media files.

In view of the foregoing, there is a demand for a docking apparatus that can receive portable media devices, such as portable media players. There is a demand for a docking apparatus for portable media devices that includes controls for command of operation of devices docked into the docking apparatus. There is another demand for a docking apparatus for portable media players that can mix media streamed a single or more than more mass storage class device, such as a portable media player. There is a demand for a docking apparatus for portable media players that duplicates the controls of a portable media player in a disc jockey style layout. There is yet another demand for a docking apparatus for portable media players that dock portable media players for display of media information thereon. There is a demand for a docking apparatus for portable media players that can adjust the volume and modify the sound profile of media being played back from the portable media players.

### SUMMARY OF THE INVENTION

The media player of the present invention preserves the advantages of prior art mixers and docking systems for portable media storage devices and portable media players. In addition, it provides new advantages not found in currently available devices and overcomes many disadvantages of such currently available devices.

The media player of the present invention is generally directed to the novel and unique docking system and mixer for portable media storage device and portable media players.

The media player includes a new and unique docking apparatus that provides control interfaces for a portable media storage device, such as a mass storage class device which includes an external hard drive (e.g. USB) or a portable media player acting in a mass storage class device mode. The devices can be, for example, can have audio and/or video files thereon.

The apparatus includes a housing having first media controls and second media controls thereon. A microcontroller resides in the housing and handles processing of media files. The first media controls and the second media controls are electrically interconnected to the microcontroller. The media storage device or devices (if multiple ones are connected) each have a first media storage component therein with at least one media items thereon. The media storage components are electrically interconnected to the microcontroller, such as by a dock interconnection. If the portable media device is a portable media player, it may be docked directly into the apparatus of the present invention so the media files on its mass storage class device storage medium therein, e.g. hard drive or RAM, can be accessed by the apparatus of the present invention.

The present invention includes a new and unique mixing controller that provides not only a control interface for controlling and commanding media on a portable media storage device connected thereto but also provides its own unique operating system for directly controlling the media. Therefore, the connected media storage devices, either via the dock connection or directly by USB, IEEE-1394 or otherwise, merely need to operate as a mass storage device where the apparatus can gain access to the files thereon. The apparatus of the present invention preferably does not access or use the media playback and operating system located on the device itself. The devices can be, for example, a portable external USB hard drive or portable media player with audio and/or video files thereon.

The apparatus includes a preferably table mounted housing with two sets of media controls thereon. For example, a hole may be provided on the bottom of the apparatus so that it can rest directly on top of a turntable where the spindle resides therein for centering, if desired.

The portable media storage device(s) are connected to the apparatus by the dock connector or USB ports or other known file transfer methodologies, such as IEEE-1394 and Bluetooth. A microcontroller resides in the housing and handles processing of media files. The first media controls and the second media controls are electrically interconnected to the microcontroller. As a result, the apparatus will have access to all of the media located on any of the connected storage devices.

The user interface is very flexible where tracks can be flagged, selected and grouped into playlists (or cue sets) for later playback and control. As a media item in the playlist next up for playback, it can be automatically sent to one side (i.e. A or B) or the other for control by the appropriate disc jockey interface controls located on the front of the apparatus. Thus, the disc jockey will not required to manually cue playback of a given file on a specific side. The apparatus can automatically control this which is a new and unique feature. Alternatively, a given media file may be manually placed on one side or the other for control by a given set of controls.

Manipulation of the first set of controls and second set of controls on the apparatus respectively commands operation of media items that have been assigned to it. Outputs connected to the portable media storage devices can be mixed and fully controlled in a disc jockey fashion. The levels of each side and master volume of the mixed outputs of the can be controlled.

### BRIEF DESCRIPTION OF THE DRAWINGS

These and other features, aspects, and advantages of the present invention will become better understood with reference to the following description, appended claims, and accompanying drawings where:

FIG. 1 is front top perspective view of the preferred embodiment of the media player of the present invention;

FIG. 2 is a rear top perspective view of the preferred embodiment of the media player of the present invention;

FIG. 3 is a front bottom perspective view of the preferred embodiment of the media player of the present invention;

FIG. 4 is a top view of the preferred embodiment of the media player of the present invention;

FIG. 5 is a plan view of an exemplary graphical interface of the media player and illustrates the step of activating the select feature of the media player by using the select knob to guide a cursor to the search selection in the menu;

FIG. 6 illustrates the step of selecting an album by using the select knob to guide a cursor to the album selection in the menu;

FIG. 7 illustrates the step of commencing a search of the available albums by guiding a cursor to the search selection in the menu using the select knob;

FIG. 8 illustrates the disc jockey entering the letter “d” into the search string using the select knob;

FIG. 9 illustrates the disc jockey further entering the letter “e” in to the search string using the select knob;

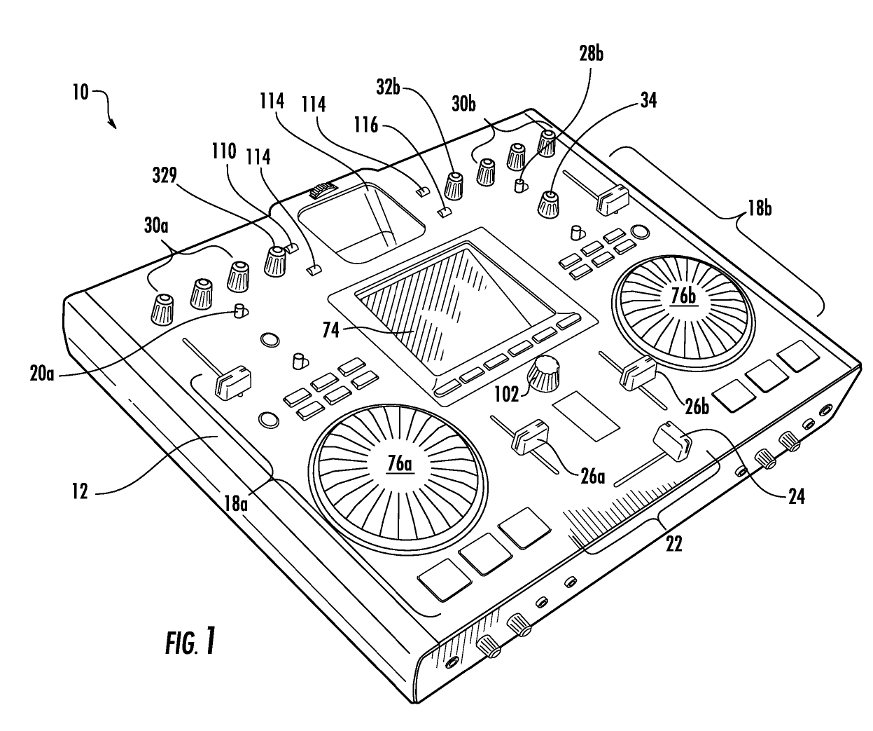

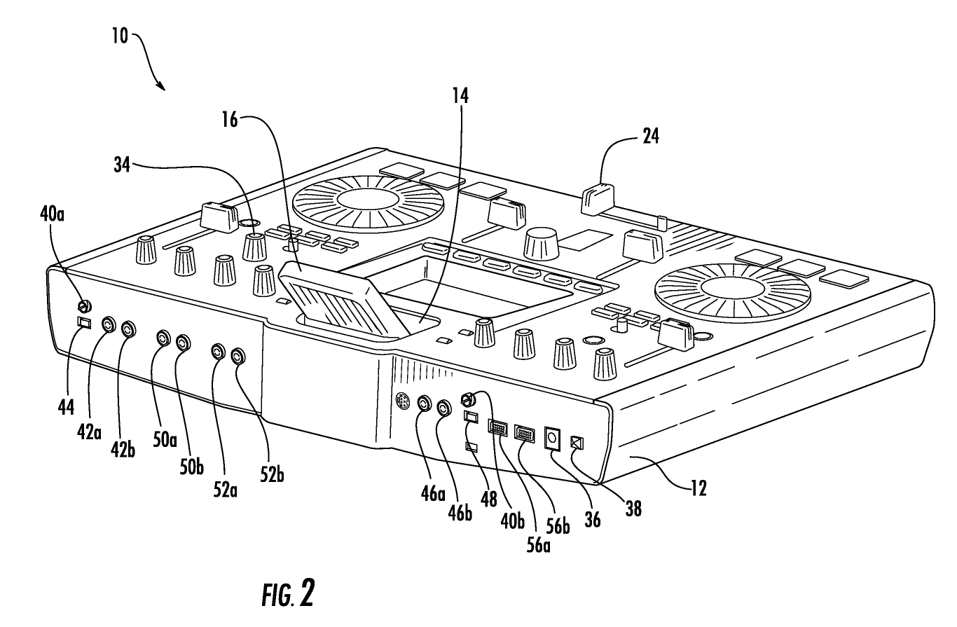

FIG. 1 0 illustrates the disc jockey executing the search by activating the multifunction key labeled “finish”;

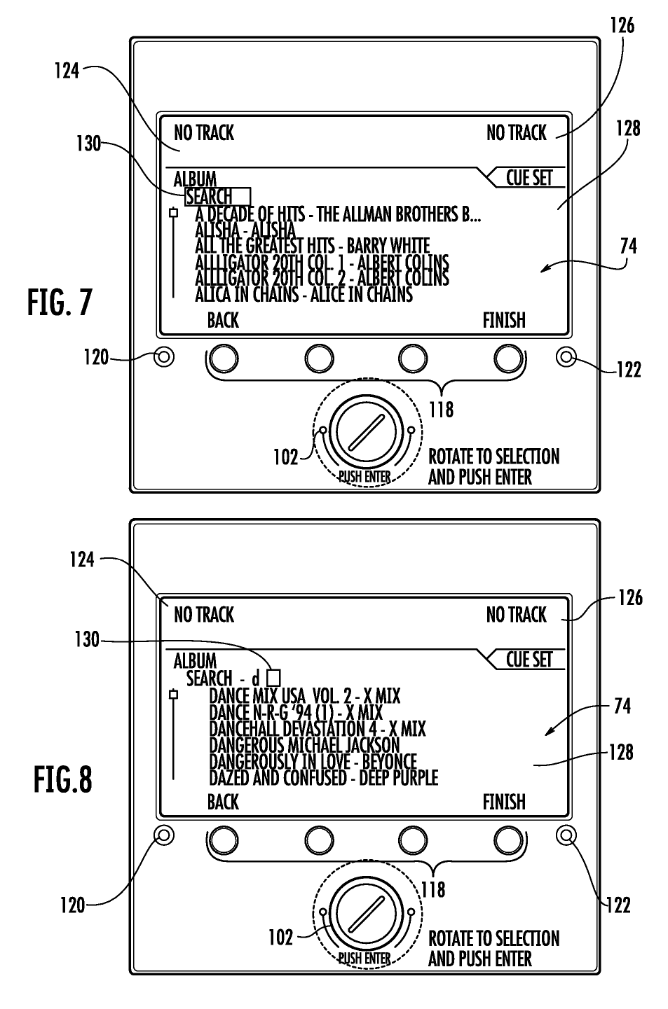

FIG. 11 illustrates the search results obtained upon execution of the search shown and described in FIGS. 7-10;

FIG. 12 illustrates the step of playing a desired album by guiding a cursor to the desired album and activating the multifunction control to assign the album to a desired deck labeled “A”;

FIG. 13 illustrates that the media tracks of the album are displayed after assigning the album to a deck to play;

FIG. 14 illustrates the step of viewing available artists on the media player using the exemplary graphical interface of the media player by using the select knob to guide a cursor to the artist selection in the menu;

FIG. 15 illustrates the step of commencing a search by artist by using the select knob to guide a cursor to the search selection in the menu;

FIG. 16 illustrates the disc jockey entering the letter “p” into the search string using the select knob;

FIG. 17 illustrates the disc jockey further entering the letter “r” in to the search string using the select knob and executing the search by activating the multifunction key labeled “finish”;

FIG. 18 illustrates the search results obtained upon execution of the search shown and described in FIGS. 15-17;

FIG. 19 illustrates the results obtained by using the select knob to guide a cursor to the desired artist, “Prince”;

FIG. 20 illustrates the step of selecting a desired track and activating the multifunction control labeled “add”;

FIG. 21 illustrates the step of adding the desired track to the flag list (or crate);

FIG. 22 illustrates the step of using the multifunction control labeled “back” in order to move the contextual level up;

FIG. 23 illustrates the results of the execution of the step described in FIG. 22;

FIG. 24 illustrates the step of using the select knob to guide a cursor to the flag list (or crate) to view media tracks and albums that have been added thereto;

FIG. 25 illustrates the step of using the select knob and multifunction control to assign a media track to the second deck labeled “B”; and

FIG. 26 shows the media track is now cued and paused in the second deck labeled “B” by the second portion of the main display screen showing the indicia thereof.

### DESCRIPTION OF THE PREFERRED EMBODIMENT

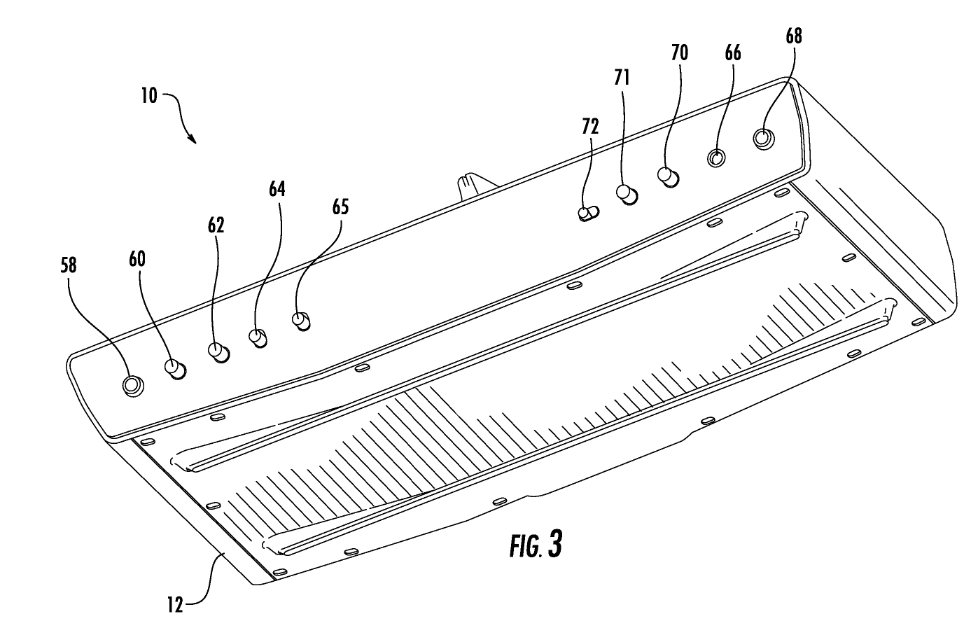

Turning first to FIG. 1, a perspective view of the media player 10 of the present invention is shown. The media player 10 includes a main housing 12 with a seat 14, to respectively receive a portable media device 16 (FIG. 2) therein. The seat 14 may be reconfigurable to accommodate portable media devices of different sizes and configurations. For example, different seat inserts (not shown) can be provided for this purpose.

The seat 14 provides a docking location for the portable media device. The seat 14 preferably includes a floor and side walls to support the outer walls of the portable media device. An interface connector is provided on the floor of the seat 14 to electrically interconnect with the portable media player itself, namely, via its bottom port.

First, by way of background, the signal mixing and control capabilities are shown in connection with FIGS. 1-5. The media player 10, includes two separate decks 18a, 18b, and collectively as 18, for generating two output signals. The controls on the left side of the media player generally form the first deck and the controls on the right side of the media player generally form the right deck. The controls in the central portion 22 of the media player 10 generally are shared between the first deck 18a and second deck 18b.

A crossfader 24 is used to mix between the two output signals emanating from the portable media device 16 or other device connected to the media player 10. Line faders 26a, 26b are provided to adjust the signal level, such as the audio signal level, for a given channel. Generally Channel 1 corresponds to the media output from the deck on the left 18a and the Channel 2 corresponds to the media output from the deck on the right 18b. An input selector 28a, 28b controls which signal is inputted into a given channel. Preferably, the signal emanating from the portable media player 16 is being routed into the mixer. However, the media player 10 may be used as a standard disc jockey mixer where any signal output may be routed into the mixing subsystem. A preferably two-position input selector is provided for each channel or side of the media player 10 where one position selects the source signal from the portable media player to be supplied to the mixer while a second position selects an alternative line in or phono position as the port for supply of signal. Details of these interconnections will be discussed in connection with FIG. 2 below.

Still further a three band equalizer 30a, 30b for each channel is provided so the user can custom adjust the sound quality of the signal being mixed and outputted. Each channel has a three band equalizer 30a, 30b to adjust treble, midrange and bass levels of the audio. Gain adjustment 32a, 32b is also provided for each channel which is used to equalize the input levels between the two sources. This is particularly useful when different audio files on different devices were recorded at different levels which result in varying output levels. Further, a master output control 34 is provided to control the master volume of the media player 10 of the present invention, which represents the playback performance. The output connectors representing such master output is discussed and shown in connection with FIG. 2 below.

Referring now to FIG. 2, details of the rear panel of the present invention can be seen. An AC in power supply connector 36 is provided to receive a power source (not shown). A 9 volt, 2.8 amp power source is preferred but other power supplies can be employed if the media player 10 is modified accordingly. Next to the power connector is a ON/OFF power button 38 to turn the media player 10 on and off. Grounding connectors 40as, 40b are provided to connect the media player 10 to a path to ground, to, for example, eliminate humming or avoid shock.

The media player 10 of the present invention provides a full array of input and output connectors for audio and video signals routed therethrough. A pair of RCA connectors 42a, 42b, for left and right stereo channels for connecting an external sound source to Channel 1 of the apparatus. An input selector switch 44 is provided to select between either line level input or phono input to Channel 1 via the RCA 42a, 42b connectors for Channel 1. Similarly, a pair of RCA connectors 46a, 46b, for left and right stereo channels for connecting an external sound source to the Channel 2 of the apparatus. An input selector switch 48 is provided for to select between either line level input or phono input to Channel 2 via the RCA connectors 46a, 46b for Channel 2.

A pair of RCA connectors 50a, 50b are provided for stereo output of the master stereo output which is the output of the media player 10 that is controlled by the Master Gain knob 34on the top panel of the media player 10. These connectors 50a, 50b are ideally used for connection of powered speakers and stereo system thereto. Another pair of RCA connectors 52a, 52b are provided for stereo output of line level. These connectors 52a, 52b are ideally used for connection of recording devices, such as CD burners, tape recorders or the line in of a sound card for a computer.

It is possible that the media item is a video file that is being played back and mixed using the apparatus of the present invention. A video output connector 54, such as an S-video connector is provided for output of video from the media player 10 to a video display, such as a computer monitor or projector (not shown).

Computer interface connectors 56a, 56b for both Channel 1 and Channel 2 are provided where a computer can be interfaced with the media player 10 for viewing, managing and organizing files directly on a portable media device 16 installed in the seat 14. For example, if the portable media device 16 is a portable media player with a hard drive therein, a USB connection is preferably provided so that a computer connected thereto with a suitable USB cable, can directly view media files and the file structure thereon. A USB 2.0 connection is preferred for this interconnection.

Turning now to FIG. 3, details of interconnections to the media player 10 of the present invention via the front control panel is shown. First, a microphone input 58 is provided where the user may connect a microphone for incorporation into the mix for output. Preferably, a female ¼ inch mono jack is provided for this purpose but other interconnections may be used. Next to the microphone input jack 58 is a microphone gain control knob 60 that controls the level of the microphone into the mixer. Also, a microphone tone knob 62 is provided which controls the tone of the microphone input signal. This is employed to improve sound quality and eliminate feedback. In general, the microphone input jack 58, microphone gain knob 60 and microphone tone knob 62 enable the user to incorporate their own voice and other ambient sounds into the mix via a microphone (not shown) connected to the input jack 58.

A unique fader start switch 64 is also provided on the front face of the media player 10 of the present invention. If desired the movement of the crossfader 24 can be employed to activate the PLAY/PAUSE function of the media player 10 (which can be also activated by the play/stutter control 82a, 82b). Such movement is activated when the fader start switch 64 is in the ON position. Movement of the crossfader 24 will not activate a PLAY/PAUSE command when the fader start switch is in the OFF position. Adjacent to the fader start switch is a crossfader contour control 65. The position of this control 65 determines how quickly or intensely the crossfader 24 will blend.

A ⅛ inch mini stereo headphone connector 66 and ¼ inch headphone connector 68 are provided so that the user can listen to the desired output of the media player 10. These two different types of headphone connectors 66, 68 gives the user flexibility of interconnectivity of headphones (not shown). The volume of the output to the headphone connectors is controlled by a cue gain knob 70. Also, a cue tone knob 71 is provided which controls the tone of the headphone output signal. This is employed to improve sound quality and eliminate feedback. Also, the output to headphones is controlled by a CUE/MIX switch 72 which is also provided on the front face of the apparatus. The CUE/MIX switch 72 is preferably a three-way switch where Channel 1 only (in the leftmost position), mixed Channel 1 and 2 together (middle position) or Channel 2 only (in the rightmost position) can be selected.

It should be understood that the various connectors, knobs, buttons and sliders are indicated. However, these are preferred configurations and other configurations are contemplated by the present invention. For example, USB connections are preferred but it is possible to employ IEEE-1394 (also known as Firewire or iLink) connections. Similarly, RCA connectors are preferred, however, optical connections, for example, may be used. While sliders are preferred for fading, such operation can be carried out by knobs.

The media player 10 includes a mixing controller that provides not only a control interface for controlling and commanding media on a first portable media storage device but also provides its own unique operating system for directly controlling the media. Therefore, the connected media storage devices merely need to operate as a mass storage device where the apparatus can gain access to the files thereon. The apparatus of the present invention preferably does not access or use the media playback and operating system located on the device itself. The devices can be, for example, a portable external USB hard drive or portable media player with audio and/or video files thereon.

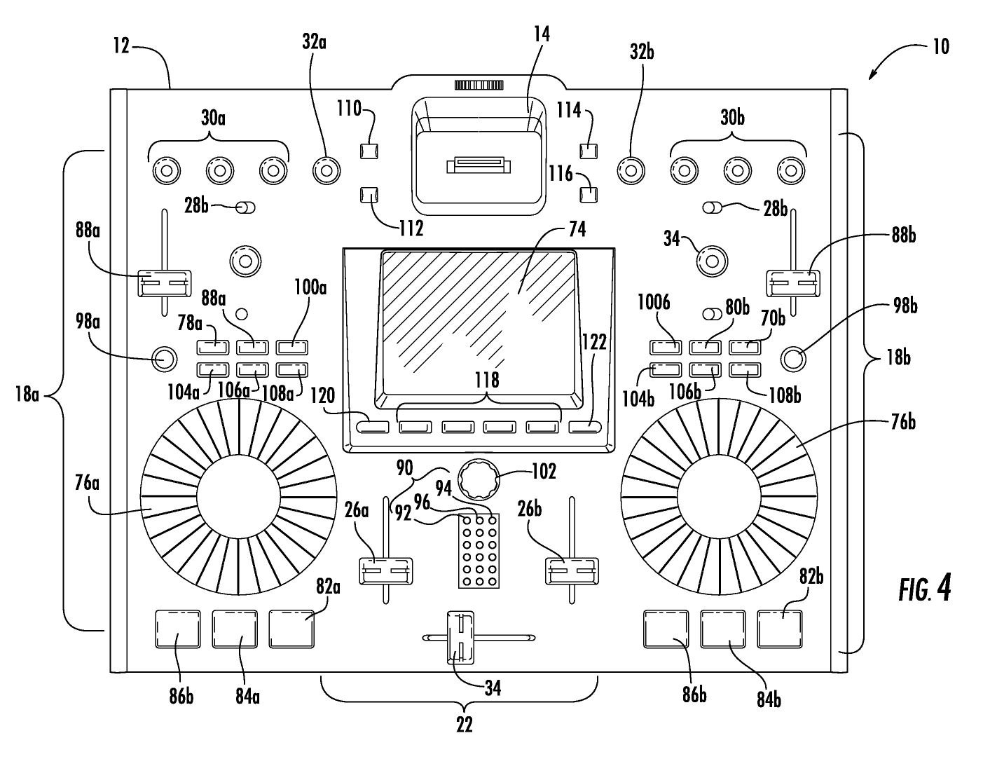

Referring to FIG. 4, the front face of the media player 10 includes a variety of controls for cueing and playing media content.

The front face can be divided roughly into three control areas, a first interface 18a to a first deck, a second interface 18b to a second deck, and a central control interface 22. The first and second interfaces 18 are identical in operation, but permit a disc jockey to cue, beat match, and play media independently on each corresponding deck. The central control interface 22 includes global controls and the main display screen 74 for both interfaces 18.

Located prominently in roughly the center of the each interface 18 is a jog wheel control 76a, 76b, are generally as 76. The jog wheel control 76 can be used for pitch bending, scratching and searching through the music playing on the respective deck. The functionality of the jog wheel control 76 is determined by the accompanying scratch control 78a, 78b and search control 80a, 80b.

While a media track is playing on the respective deck, the jog wheel control functions 76 as a pitch bend. Pitch bending temporarily speeds up (turn clockwise) or slows down (turn counter-clockwise) the media. This technique is used when to adjust two beat-matched tracks that may not be completely synchronized. Hence, with pitch bending a disc jockey can temporarily slow down or speed up the track that is being mixed so its beats are synchronous with the beats of the other track that is already playing on the other deck.

While a media track is paused, a disc jockey can use the jog wheel control 76 to seek through the music to a new cue point location. Activating the respective play/stutter control 82a, 82b following the adjustment of the jog wheel control 76 sets the cue point at the new selected location.

A scratch control 78a, 78b, is further provided to engage scratch mode. In scratch mode, the jog wheel control 76 allows a disc jockey to apply a scratch-effect to the media track in much the same way that disc jockeys scratch a vinyl record. As the media track is playing, shifting the jog wheel control 76 back and forth creates a scratching effect. When the jog wheel control 76 is held stationary, normal playback of the media track resumes. To resume play with no gap in the audio, “push off” by scratching forward at approximately normal playback speed before releasing the jog wheel control 76.

Further included on each interface 18 is a respective search control 80a, 80b to engage search mode. Search mode allows the disc jockey to use the jog wheel control 76 to quickly scan through the current media track. If the disc jockey does not touch the jog wheel control 76 for a short period (approximately eight seconds) the respective deck automatically exits search mode.

A play/stutter control 82a, 82b is also included on each respective deck. Activating the play/stutter control starts the currently selected in the deck. A cue point is set at the current position and the media begins playing. Activating the play/stutter control 82a, 82b while the media player 10 is playing restarts the media from the cue point, which can be used to create a “stutter” effect.

Further included is a pause control 84a, 84b. The pause control 84a, 84b stops the media track playing on the corresponding deck. Activating and holding the pause control 84a, 84b for approximately one second while paused, returns the playback of the media to the beginning of the selected track.

Further included is a cue control 86a, 86b. The cue control 86a, 86b returns and simultaneously pauses the media at the last set cue point. As described earlier, a cue point is the last place where play/stutter control 82a, 82b was activated or the start of the track, if the play/stutter control 82a, 82b has not been activated. By activating and holding the cue control 86a, 86b, the respective deck of the media player 10 will begin playing the selected media track for as long as the cue control 86a, 86b is held active. Once the cue control 86a, 86b is released, the media player 10 will jump back and pause at the cue point.

A cue point can be easily edited by spinning the jog wheel control 76 to a new position while paused. As the disc jockey spins the jog wheel control 76, the media track will sound. By stopping the jog wheel control 76 and activating the play/stutter control 82a, 82b, a new cue point is set.

Each interface 18 of each deck further includes a pitch slider control 88a, 88b, which is used to control the speed (or pitch) of the media track. Moving the slider toward “−” results in a lower pitch (and slower tempo) of the media track, while moving the slider toward “+” results in a higher pitch (and faster tempo) of the media track.

The media player 10 includes a beat keeper that automatically tracks beats based upon a combination of frequencies and rhythm patterns in the media currently playing. It shows beats per minute (“BPM”) in a beat display 90 and outputs 4-count (i.e. one measure) information about the media track in a marching bar graph. The beat display 90 includes a left bar 92, a right bar 94 and a middle bar 96. The left bar 92 represents the beat of the media playing on the first deck, while the right bar 94 represents the beat of the media playing on the second deck. The middle bar 96 indicates when the downbeats of the media playing on both decks occur simultaneously in order to aid the disc jockey in beat matching two different tracks of media.

A tap control 98a, 98b is further provided each interface 18 of each deck. Activating the respective tap control 98a, 98b in time with the beat of the media currently playing will aid the beat keeper in detecting the proper tempo. Activating and holding active the tap control 98a, 98b for approximately one second resets the beat keeper and causes it to recalculate the BPM.

A mode control 100a, 100b is also provided on each interface. Activating the mode control 100a, 100b invokes a menu on the main display 74 screen that includes deck options, such as pitch range, time display and fader start. The disc jockey can subsequently use the select knob 102, described in detail below, to dial in the desired values and pressing down on the select knob 102 will move on to the next option. Activating the mode control 100a, 100b again exits the deck options menu.

Each interface 18 also includes a set of loop controls. In particular, there is a loop in control 104a, 104b, a loop out control 106a, 106b, and a re-loop control 108a, 108b.

The loop in control 104a, 104b is used to set a “loop in” point in the media track. By default, a “loop in” point is automatically set to the current cue point (which defaults to the beginning of the track). A new “loop in” point is defined by activating the loop in control 104a, 104b when the media track reaches the desired point. A loop in indicator within the loop in control 104a, 104b will light, indicating a new “loop in” point has been set. A new loop in point can be set by merely activating the loop in control 104a, 104b again at the new desired location within the media track.

The loop in control 104a, 104b can also be used to create a new cue point. Activating the loop in control 104a, 104b sets a cue point will be set at that location also. The disc jockey can return to this new cue point by activating and holding the cue control 86a, 86b while simultaneously activating the loop in control 104a, 104b. The deck will pause and return to the loop in point. Playback can be resumed by subsequently activating the play/stutter control 82a, 82b.

The loop out control 106a, 106b is used to set the end point of the loop. The first time the loop out control 106a, 106b is activated while a media track is playing, an indicator in the loop out control 106a, 106b will blink and the media track will begin playing in a seamless loop starting from the “loop in” point and ending at the “loop out” point. To release or end the loop, the loop out control 106a, 106b is activated a second time. Play continues forward when the media track passes the previously set loop out point. The indicator in the loop out control 106a, 106b will continuously light, indicating that the loop is now stored in memory for re-looping purposes later.

Like the loop in control 104a, 104b, the loop out control 106a, 106b can also be used to create a new cue point. Activating the loop out control 106a, 106b sets a cue point at that location also. The disc jockey can return to this new cue point by activating and holding cue control 86a, 86b while simultaneously activating the loop out control 106a, 106b. The deck will pause and return to the loop out point. Playback can be resumed by subsequently activating the play/stutter control 82a, 82b.

The re-loop control 108a, 108b repeats play of the media track from the loop in point. If a loop has been set, it plays and repeats a previously set loop, until it is released by activating the loop out control. By activating the re-loop control 108a, 108b repeatedly, a stutter effect can be made.

The central control interface 22 contains the global controls for the media player, such as navigation and function controls, as well as the beat keeper display 90 and the main display screen 74. The main display screen 74 displays information about the media player, the decks and any attached peripheral devices, such as removable hard discs or portable media playing devices.

Further included is a menu select knob 102. The menu select knob 102 is used to navigate lists, change settings, and operate various parts of the graphical user interface. The menu select knob 102 can be rotated and pressed to select or change a highlighted item within the graphical user interface menus displayed on the main display screen 74.

Further included is a library selection control 110. The library selected control 110 allows the disc jockey to access the library of media stored on removable media connected to the media player 10 through one of the USB ports 56a, 56b or the portable media device 16.

Further included is a crate control 112. The crate control 112 allows the disc jockey to view the media tracks that have been labeled as being in the crate (or flag list). While viewing media tracks in the crate (or flag list), the disc jockey can use the multifunction controls 118 below the main display screen 74 to send tracks to either deck for mixing, pull them back into the crate for later use if they are already playing, or remove them from the crate altogether. The disc jockey may also switch the media track order in the crate, by using the selected knob 102.

Further included a utility control 114. Activating the utility control 114 invokes a utility menu to display on the main display 74. In the utility menu, the disc jockey can adjust display preferences, restore settings to their factory default state and calibrate the pitch sliders 88a, 88b.

Further included is a view control 116. The view control 116 is used to access different information about the media playing on either of the decks. The view control 116 also toggles between track information and a track profile view of the media track playing.

A track profile is a visual representation of a media track, designed for quick and easy identification of phrases or segments within that media track, differentiated by their “energy”. Distinct from a waveform, a profile doesn't show every small detail of the track, just the big changes in terms of energy.

The track profile is split into three shades of grey, with black making up the total number of variations to four. The white portions of the track indicate high energy and volume, graduating down to the black sections representing quieter phrases. The length of each profile is scaled to exactly fit the available work area on the main display screen, so the entire track is always visible.

Four multifunction controls 118 are found below the main display screen 74. The four multifunction controls 118 are used to select from available menu items displayed on the on the main display screen 74. Depending on the menu that is being viewed, the functionality of the individual multifunction controls 118 will change. The main display screen 74 will display one or more icons directly above each multifunction controls 118 indicating the function of each particular multifunction control 118, respectively.

On either side of the four multifunction controls 118 are a left page control 120 and right page control 122. The left page control 120 and the right page control 122 are used to scroll through available pages of selections, when available. If there are additional pages to be viewed, a left or right arrow icon is displayed on the display screen 74 above the left or right page controls 120, 122, respectively. The left page control 120 and the right page control 122 may also be used to move a cursor 130 when entering text in the main display screen 74.

The media player 10 is capable of playing media files stored in popular formats, such as MP3, WAV and AAC music formats. Moreover, the media player 10 is capable of reading and controlling file systems stored in FAT16, FAT32, NTFS (read-only) and HFS+ formats. The media player 10 directly controls devices in these formats rather than working through the device itself or a proxy. This feature allows the media player 10 to be responsive and avoids latency and compatibility problems.

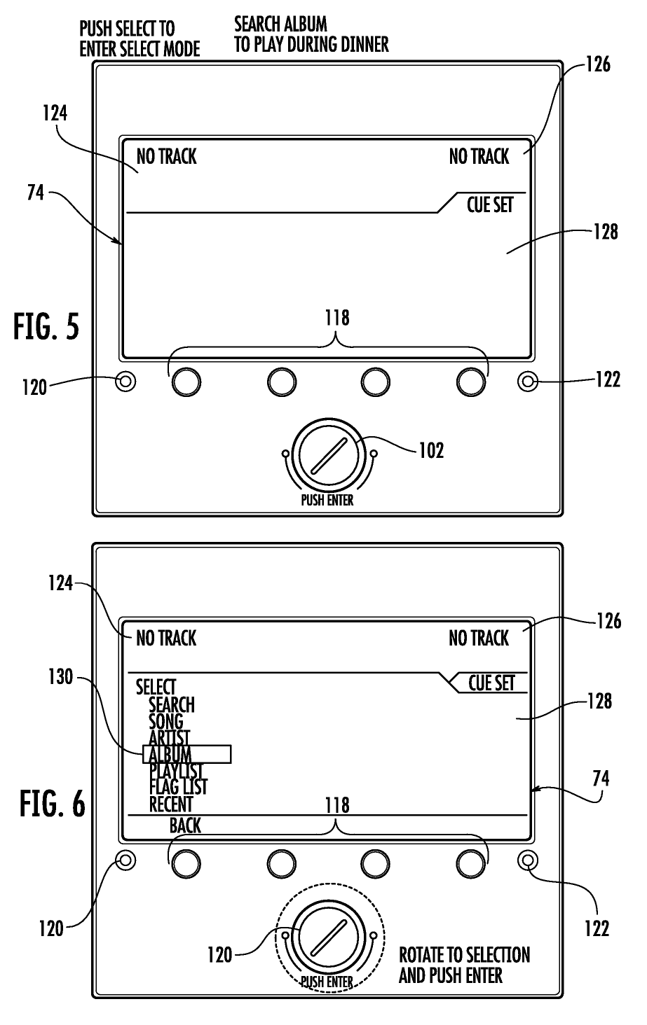

Turning now to FIG. 5, a close up view of an embodiment of the main display screen 74 and central control interface 22 is shown. The main display screen 74 is divided into roughly three display areas. The upper left portion 124 of the main display screen 74 includes information relating to the first deck. The upper right portion 126 of the main display screen 74 includes information relating the second deck. The lower portion 128 of the main display 74 screen includes the menus for selecting media and setting the options of the media player 10. The lower portion 128 also includes the menu bar that indicates the functions of the various multifunction controls 118 below the main display screen 74.

Pressing either the crate control 112 or the library control 110 invokes a select menu that is displayed on the lower portion 128 of the main display 74 screen shown in FIG. 6. The library control 110 displays all media tracks available, whereas the crate control 112 only shows a select portion of all the media tracks available. The lists are organized by song, artist, album, playlist, flag list (or crate) and recently played media tracks. The disc jockey can then rotate the select knob 102 to cause the cursor 130 to highlight a desired choice in the menu on the lower portion 128 of the main display screen 74, such as available albums for instance, and press the select knob 102 to select the desired choice. Referring the FIG. 7, after selecting the album selection, a list of all available albums is displayed in the lower portion of the main display screen.

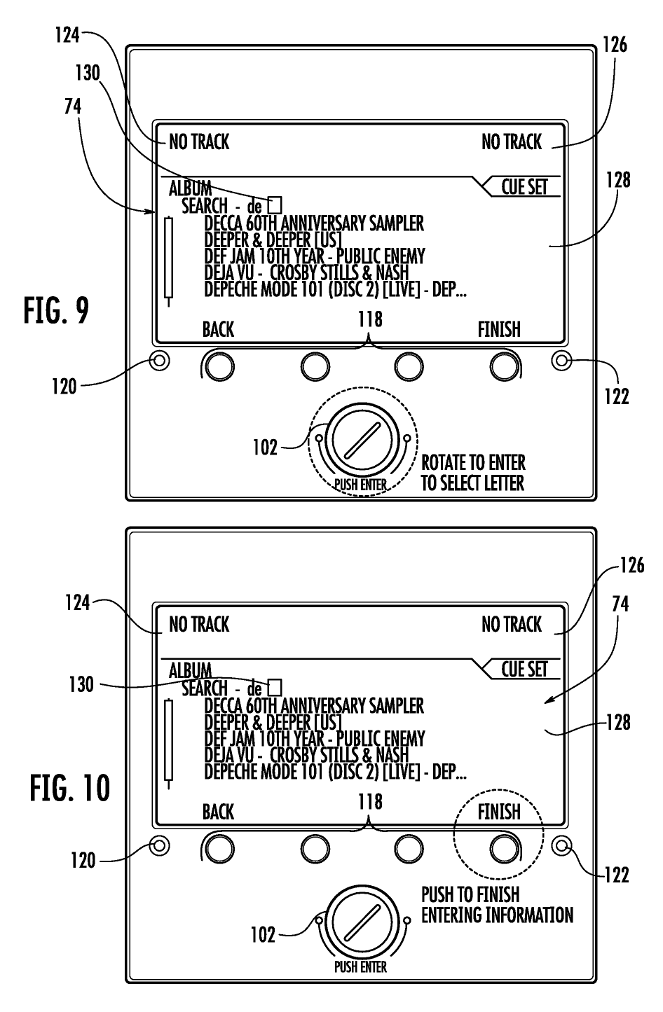

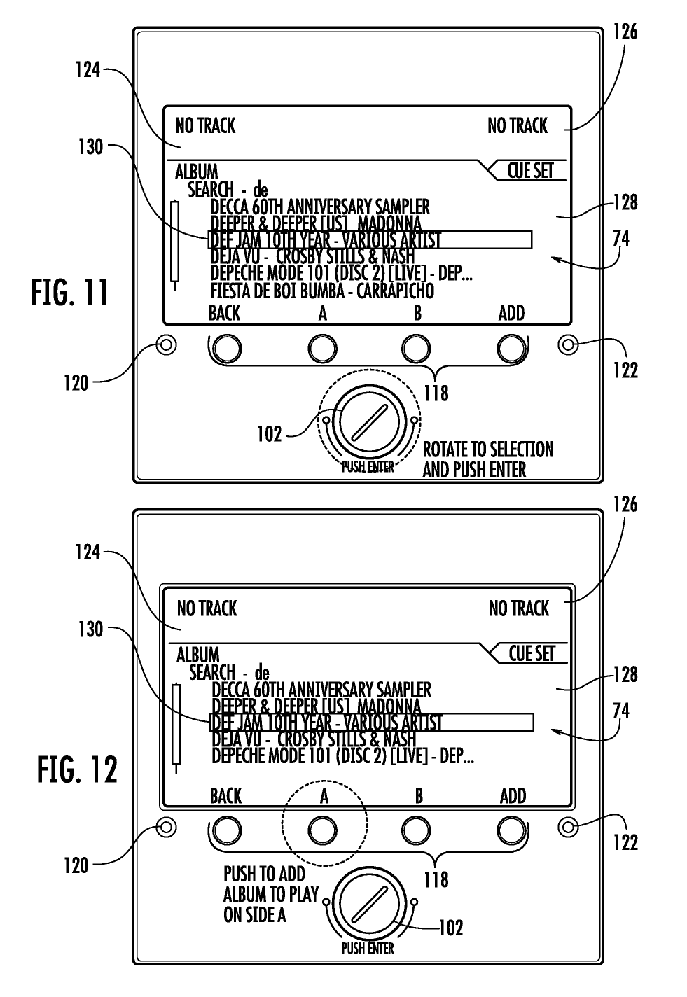

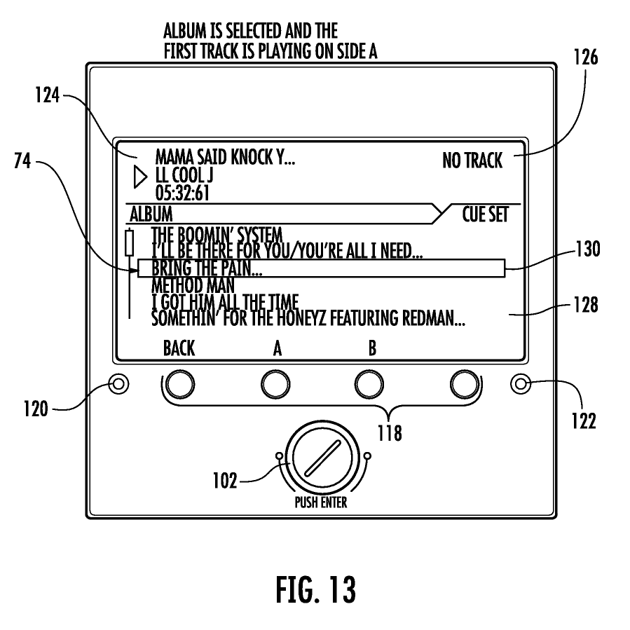

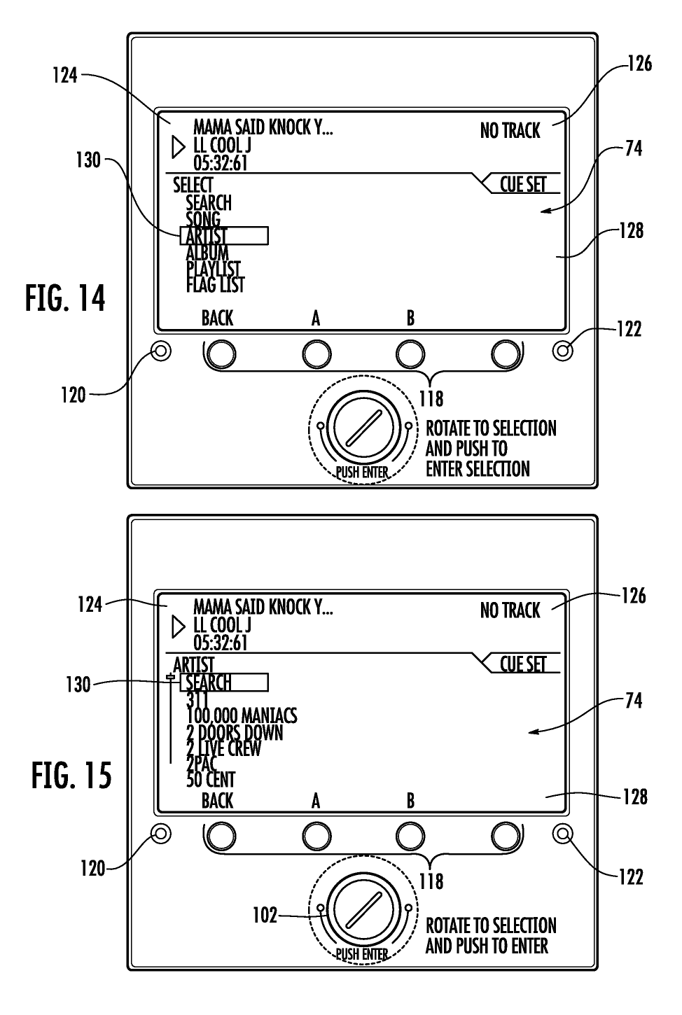

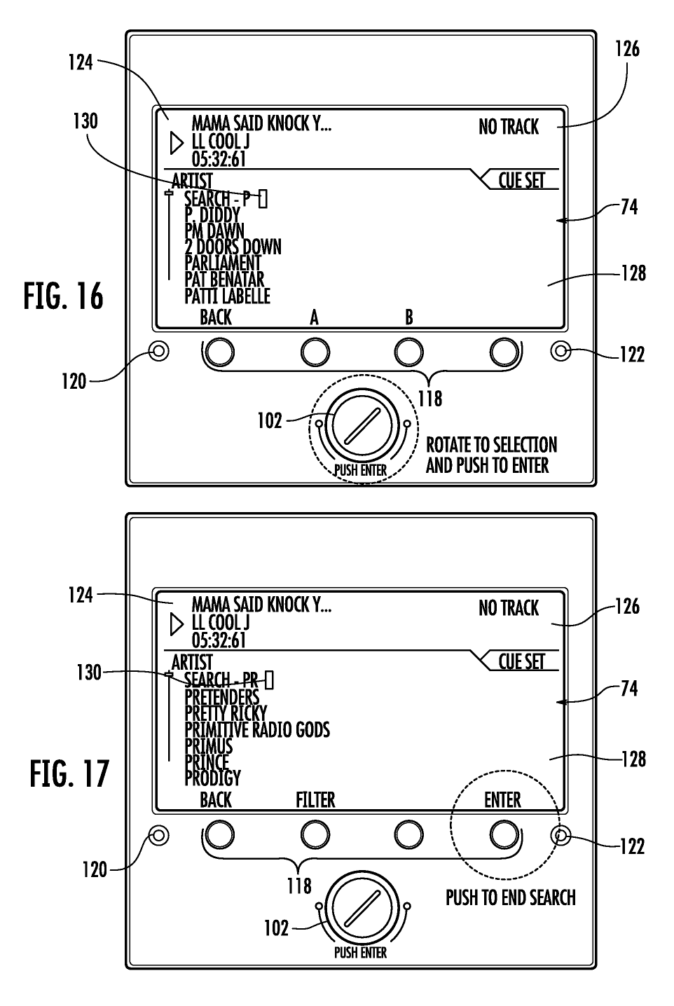

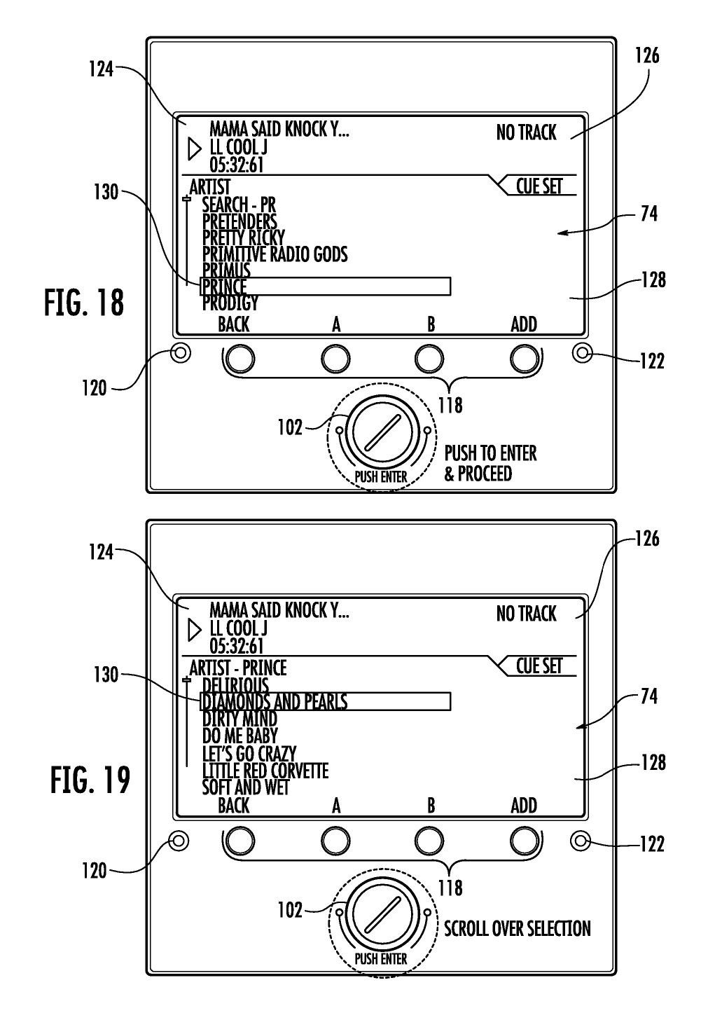

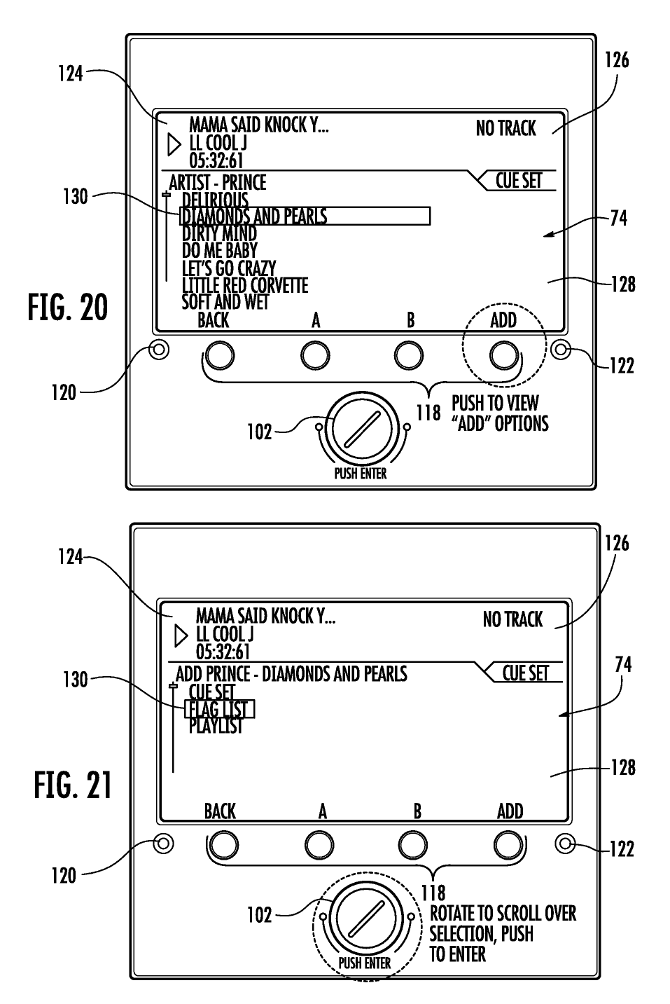

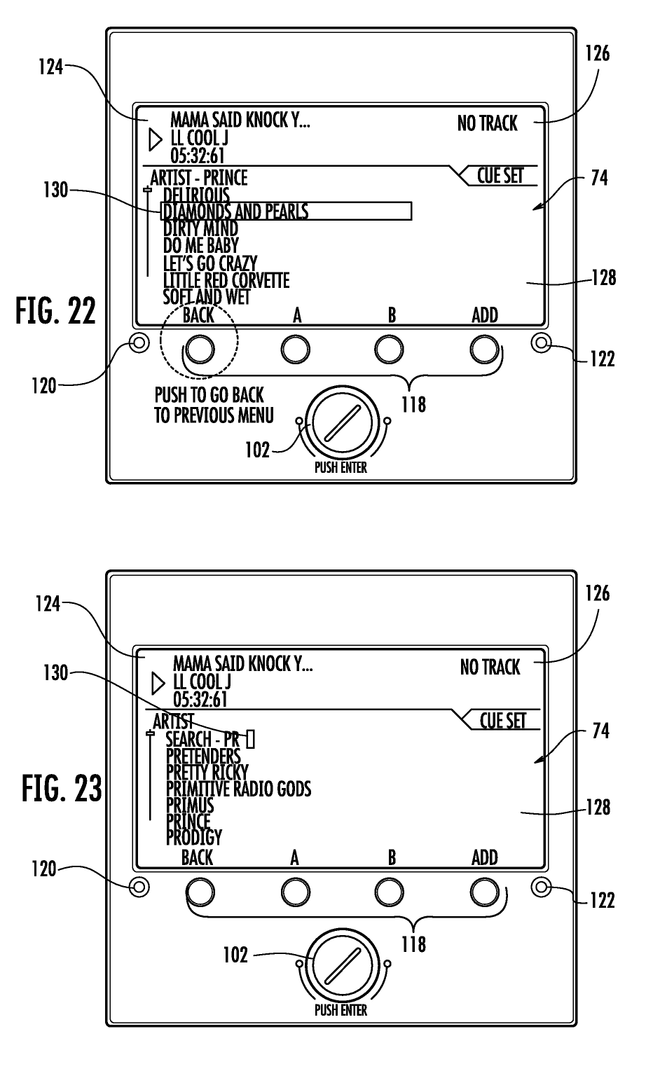

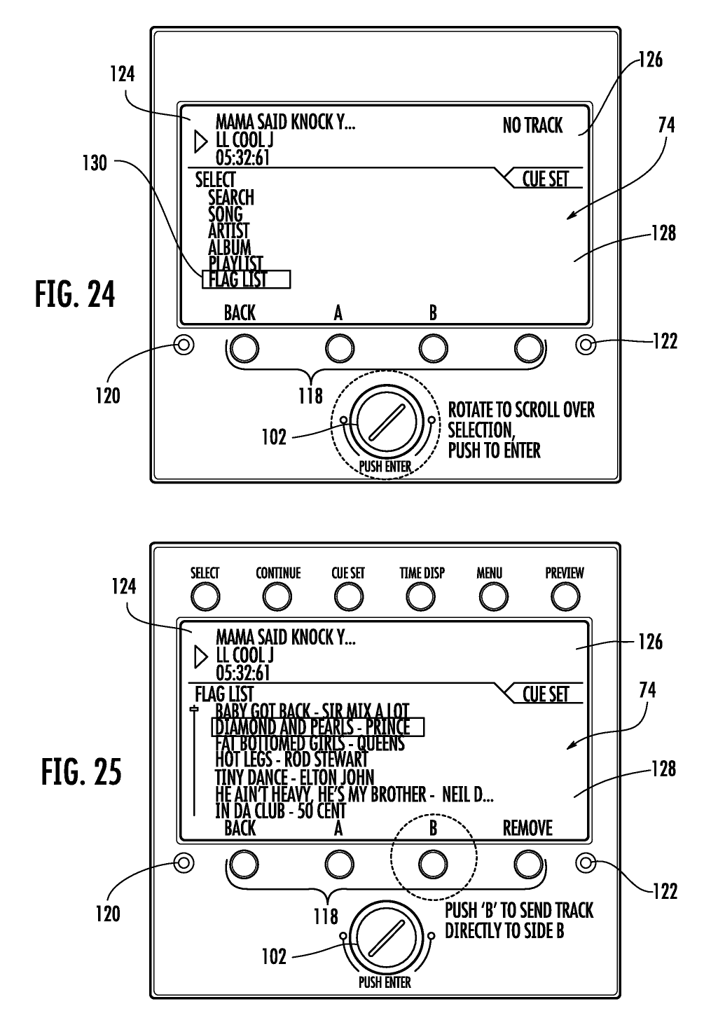

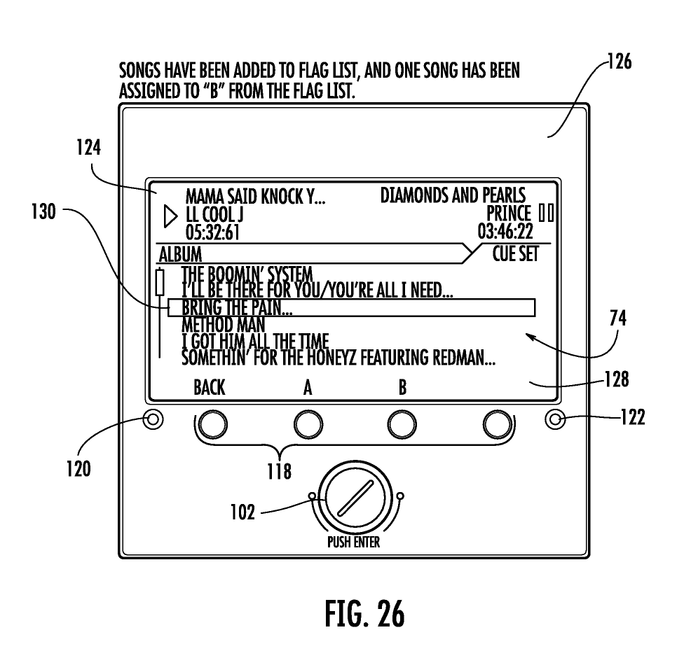

If the disc jockey desires to search for a particular album, the disc jockey uses the select knob 102 to move the cursor 130 to highlight the search selection on the menu and presses the select knob 102 as shown in FIG. 7. After pressing the select knob 102, the disc jockey may enter the text of the characters that the disc jockey desires to search on by rotating and pressing the select knob 102. For example, referring the FIGS. 8 and 9, the disc jockey has selected the letters “d” and “e”. After the desired text is entered, the disc jockey may execute the search by activating the multifunction control 118 that is indicated as “finish”, as shown in FIG. 10. Alternatively, the disc jockey may enter text using a keyboard attached to one of the USB ports 56a, 56b.

Referring to FIG. 11, a list of all albums with titles beginning with the letters “de” is displayed. The disc jockey can then select with the cursor 130 and assign an entire album to one of the decks by using the select knob 102 and desired multifunction control 118 as shown in FIG. 12. Referring to FIG. 13, after assigning the album to one of the decks, a list of the media tracks within the album is displayed and the first media track begins play. The first portion 124 of the main display screen 74 indicates that the first track of the album is now playing.

If the disc jockey desires to cue more media tracks to play, he merely activates the library control 110 or crate control 112 to return the main menu as shown in FIG. 14. For instance, if the disc jockey desires to add music to the play list from a particular artist, the disc jockey uses the select knob 102 to guide the cursor 130 to the artist selection on the menu in the lower portion 128 and presses the select knob 102. A list of available artists is then displayed in the lower portion as shown in FIG. 15. If the disk jockey desires to search for media tracks by the artist Prince, for instance, the disc jockey selects the search icon in the list. Referring to FIGS. 16 and 17, the disc jockey can then enter the letters “p” and “r” with the select knob 102 or keyboard and activate the multifunction key 118 labeled “enter” to commence the search. Referring to FIG. 18, a list of all artists with titles beginning with the letters “pr” is displayed in the lower portion 128. The select knob 102 can then be used to select “prince” from the list. Referring to FIG. 19, a list of all of the media tracks by the artist Prince is displayed. The disc jockey can then use the select knob 102 to guide the cursor 130 to the title of a particular media track. By using the multifunction control 118 labeled “add”, as shown in FIGS. 20 and 21, the disc jockey can then append the selected media track the flag list (or crate), a playlist, or, alternatively, set a cue point within the track.

Referring to FIGS. 22 and 23, activating the multifunction control labeled 118 “back” brings the cursor up one contextual level.

Referring to FIG. 24, the disc jockey can view the contents of the crate or the flag list by one of two methods. In particular, the disc jockey can activate the crate control 112 as described above earlier, or the disc jockey may use the select knob 102 from the library control menu to select the flag list (or crate). In either case, the contents of the crate are displayed as shown in FIG. 25. The disc jockey my then cue and play a media track on the second deck, for instance, by selecting the media track by using the select knob 102 to guide the cursor 130 to the desired selection and subsequently activating the appropriate multifunction control 118. The selected track is then displayed in the second portion 126 of the main display screen 74 as indicated on FIG. 26.

Media tracks may also be searched for and selected by song title, recently played and playlist also. Through use of the select knob 102 and multifunction controls 118, playlists may be created and media tracks added thereto.

Therefore, it can be seen that the media player of the present invention provides a unique solution to the problem of providing a disc jockey a media player that includes a docking station for a portable media device, such as an iPod®, that includes the capabilities of cueing and playing media tracks with the features of a mixing console, coupled with the features of a unique and advanced user interface that obviates the need to use the operating system of the portable media device.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A media player for a disc jockey, comprising:
a housing including front face, a top surface, a rear face;
a surface defining a seat on the top surface of the housing; said seat configured and arranged to received a portable music player therein and further including an input port communicatingly connecting to said portable media player, said portable media device having a plurality of media tracks stored thereon;
a master output;
a first deck having a first media control interface configured and arranged to cue and play media tracks on a first channel, said first media control interface located on said top surface of said housing;
a second deck having a second media control interface configured and arranged to cue and play media tracks on a second channel, said second media control interface located on said top surface of said housing;
a global control interface including a main display screen located on said front face of said housing, a select knob being rotatable and pressable for navigating menus and selecting menu choices contained therein, and plurality of multifunction controls having contextual function labels associated therewith for navigating menus and selecting menu choices contained therein; and
a mixing controller communicatingly connected to said first interface, said second interface said global control interface, said input port, said master output for accessing and controlling said portable media device according to selections made on said first interface, said second interface and said global control interface, and selectively mixing said the first channel and the second channel into a mixed signal and routing said mixed signal out through said master output.

2. The media player of claim 1, further comprising:
a crossfader control for selectively switching between the first channel to the second channel for output through the master output.

3. The media player of claim 1, further comprising:
a beat keeper having first display, second display and third display;
said first display indicating the beats of a media track playing on said first deck;
said second display indicating the beats of a media track playing on said second deck;
said third display indicating when the downbeats of the media tracks playing on the first deck and second deck, respectively, occur simultaneously.

4. The media player of claim 1, further comprising:
a crate control for sorting a portion of said plurality of media tracks into a set for use at a disc jockey performance.

5. The media player of claim 1, wherein said main display screen further comprises:
a first portion containing first indicia of said first deck;
a second portion containing second indicia of said second deck; and
a third portion containing third indicia of said plurality of media tracks;

6. The media player of claim 5, wherein said third portion of said main display screen further includes said third indicia of said plurality of media tracks organized by artist, album, playlist, and song title, respectively.

7. The media player of claim 1, further comprising a view control, said view control displaying a first track profile of a first media track playing on the first deck juxtaposed to a second track profile of a second media track playing on the second deck on the third portion of the main display screen to provide a graphical representation of the energy to the first media track and the second media track.

8. A media player for disc jockeys, comprising:
a housing including front face, a top surface, a rear face;
a surface defining a seat on the top surface of the housing; said seat configured and arranged to received a portable music player therein and further including an input port communicatingly connecting to said portable media player, said portable media device having a plurality of media tracks stored thereon;
a master output;
a first deck having a first media control interface configured and arranged to cue and play media tracks on a first channel, said first media control interface located on said top surface of said housing;
a second deck having a second media control interface configured and arranged to cue and play media tracks on a second channel, said second media control interface located on said top surface of said housing;
a global control interface including a main display screen located on said front face of said housing, a select knob being rotatable and pressable for navigating menus and selecting menu choices contained therein, and plurality of multifunction controls having contextual function labels associated therewith for navigating menus and selecting menu choices contained therein;
said main display screen having a first portion containing first indicia of said first deck, a second portion containing second indicia of said second deck, and a third portion containing third indicia of said plurality of media tracks; and
a mixing controller communicatingly connected to said first interface, said second interface said global control interface, said input port, said master output for accessing and controlling said portable media device according to selections made on said first interface, said second interface and said global control interface, and selectively mixing said the first channel and the second channel into a mixed signal and routing said mixed signal out through said master output.

9. The media player of claim 8, further comprising:
a beat keeper having first display, second display and third display;
said first display indicating the beats of a media track playing on said first deck;
said second display indicating the beats of a media track playing on said second deck;
said third display indicating when the downbeats of the media tracks playing on the first deck and second deck, respectively, occur simultaneously.

10. The media player of claim 8, further comprising:
a crate control for sorting a portion of said plurality of media tracks into a set for use at a disc jockey performance.

11. The media player of claim 8, wherein said third portion of said main display screen further includes said third indicia of said plurality of media tracks organized by artist, album, playlist, and song title, respectively.

12. The media player of claim 8, further comprising a view control, said view control displaying a first track profile of a first media track playing on the first deck juxtaposed to a second track profile of a second media track playing on the second deck on the third portion of the main display screen to provide a graphical representation of the energy to the first media track and the second media track.

13. A media player for disc jockeys, comprising:
a housing including front face, a top surface, a rear face;
a surface defining a seat on the top surface of the housing; said seat configured and arranged to received a portable music player therein and further including an input port communicatingly connecting to said portable media player, said portable media device having a plurality of media tracks stored thereon;
a master output;
a first deck having a first media control interface configured and arranged to cue and play media tracks on a first channel, said first media control interface located on said top surface of said housing;
a second deck having a second media control interface configured and arranged to cue and play media tracks on a second channel, said second media control interface located on said top surface of said housing;
a global control interface including a main display screen located on said front face of said housing, a select knob being rotatable and pressable for navigating menus and selecting menu choices contained therein, and plurality of multifunction controls having contextual function labels associated therewith for navigating menus and selecting menu choices contained therein, a crossfader control for selectively switching between the first channel to the second channel for output through the master output; and
a mixing controller communicatingly connected to said first interface, said second interface said global control interface, said input port, said master output for accessing and controlling said portable media device according to selections made on said first interface, said second interface and said global control interface, and selectively mixing said the first channel and the second channel into a mixed signal and routing said mixed signal out through said master output.

14. The media player of claim 13, further comprising:
a crate control for sorting a portion of said plurality of media tracks into a set for use at a disc jockey performance.

15. The media player of claim 13, further comprising:
a beat keeper having first display, second display and third display;
said first display indicating the beats of a media track playing on said first deck;
said second display indicating the beats of a media track playing on said second deck;
said third display indicating when the downbeats of the media tracks playing on the first deck and second deck, respectively, occur simultaneously.

16. The media player of claim 13, further comprising a view control, said view control displaying a first track profile of a first media track playing on the first deck juxtaposed to a second track profile of a second media track playing on the second deck on the third portion of the main display screen to provide a graphical representation of the energy to the first media track and the second media track.

17. The media player of claim 13, wherein said main display screen further comprises:
a first portion containing first indicia of said first deck;
a second portion containing second indicia of said second deck; and
a third portion containing third indicia of said plurality of media tracks;

18. The media player of claim 13, wherein said third portion of said main display screen further includes said third indicia of said plurality of media tracks organized by artist, album, playlist, and song title, respectively.
